(19) United States
(12) Patent Application Publication
(10) Pub. No.: US 2026/0208492 A1
(43) Pub. Date: Jul. 23, 2026

(54) INK CARTRIDGE, INK CARTRIDGE MANUFACTURING METHOD, AND PRINTING APPARATUS

(71) Applicant: MIMAKI ENGINEERING CO., LTD., Nagano (JP)

(72) Inventor: Tetsuharu Ikeda, Nagano (JP)

(73) Assignee: MIMAKI ENGINEERING CO., LTD., Nagano (JP)

(21) Appl. No.: 19/141,057

(22) PCT Filed: Feb. 19, 2024
(86) PCT No.: PCT/JP2024/005654

§ 371 Date: Jun. 19, 2025

(30) Foreign Application Priority Data
Feb. 21, 2023 (JP) 2023-025430
Dec. 20, 2023 (JP) 2023-214918

(51) Int. Cl. B41J 2/175

(52) U.S. Cl. CPC B41J 2/17523; B41J 2/17513; B41J 2/17553; B41J 2/17559; B41J 2002/17516

(57) ABSTRACT

An ink cartridge includes: an ink pack unit having a bag member and a rib member, the bag member housing ink and shrinking in volume housing the ink as a remaining amount of the ink decreases, the rib member having a flat plate shape and being fixed to the bag member so as to move along with shrinkage of the bag member; a head unit coupled to the ink pack unit and connected to a printing apparatus; and a case unit that houses the ink pack unit and the head unit such that a part of the head unit is exposed, in which the ink pack unit has a surface fixed to an inner surface of the case unit, the surface being opposite to a portion to which the rib member is fixed of the bag member, the case unit has a through hole, and the rib member has a projection.

### TECHNICAL FIELD

The present invention relates to an ink cartridge, a manufacturing method of the ink cartridge, and a printing apparatus.

### BACKGROUND ART

In a printing apparatus or the like having an inkjet-type head, an ink cartridge is used as a supply source for supplying ink to a head (See, for example, Patent Literature 1).

### CITATION LIST

### Patent Literature

Patent Literature 1: Japanese Translation of PCT International Application Publication No. 2011-519795

### SUMMARY OF INVENTION

### Technical Problems

In recent years, there is an increasing demand for reducing usage of plastic having a heavy burden on the environment in various products. Accordingly, also in the ink cartridge, there is a demand for a configuration with reduced usage of such plastic having a heavy burden on the environment.

The present invention has been made in view of the above, and an object of the present invention is to provide an ink cartridge, a manufacturing method of the ink cartridge, and a printing apparatus capable of reducing usage of plastic having a heavy burden on the environment.

### Solutions to Problems

An ink cartridge according to the present invention includes: an ink pack unit having a bag member and a rib member, the bag member housing ink and shrinking in volume housing the ink as a remaining amount of the ink decreases, the rib member having a flat plate shape and being fixed to the bag member so as to move along with shrinkage of the bag member; a head unit coupled to the ink pack unit and connected to a printing apparatus; and a case unit that houses the ink pack unit and the head unit such that a part of the head unit is exposed, in which the ink pack unit has a surface fixed to an inner surface of the case unit, the surface being opposite to a portion to which the rib member is fixed of the bag member, the case unit has a through hole penetrating inside and outside, the rib member has a projection provided so as to protrude outside from the through hole when the remaining amount of the ink becomes smaller than a predetermined value, the rib member and the head unit are formed using a first material having a predetermined bending strength to prevent deformation of the rib member and the head unit when connected to the printing apparatus, and the case unit is formed using a second material different from the first material.

A manufacturing method of an ink cartridge according to the present invention is a manufacturing method of an ink cartridge that includes: a bag member that houses ink and shrinks in volume as a remaining amount of the ink decreases; a rib member having a flat plate shape and having a predetermined projection, the rib member being formed using a first material having a predetermined bending strength to prevent deformation of the rib member when connected to a printing apparatus; a head unit formed using the first material and connected to the printing apparatus; and a case unit formed using a second material different from the first material and having a predetermined through hole, the manufacturing method including: an ink pack forming step of forming an ink pack unit in which the rib member is fixed to the bag member so as to move along with shrinkage of the bag member; a coupling step of coupling the head unit to the ink pack unit; and a housing step of housing the ink pack unit and the head unit in the case unit so that a part of the head unit is exposed.

A printing apparatus according to the present invention includes: a main body that performs printing with ink; and a mounting part provided in the main body and to which the ink cartridge as a supply source of the ink is mounted.

### Effect of the Invention

According to the present invention, it is possible to provide an ink cartridge, a manufacturing method of the ink cartridge, and a printing apparatus capable of reducing usage of plastic having a heavy burden on the environment.

### BRIEF DESCRIPTION OF THE DRAWINGS

FIG. 1 is a view illustrating an example of an ink cartridge according to a present embodiment.

FIG. 2 is a view illustrating an example of the ink cartridge according to the present embodiment.

FIG. 3 is a view illustrating an example of the ink cartridge according to the present embodiment.

FIG. 4 is an enlarged view of a part of the inside of the ink cartridge.

FIG. 5 is a flowchart illustrating an example of a manufacturing method of the ink cartridge according to the present embodiment.

FIG. 6 is a view illustrating an example of a manufacturing process of the ink cartridge.

FIG. 7 is a view illustrating an example of the manufacturing process of the ink cartridge.

FIG. 8 is a view illustrating an example of the manufacturing process of the ink cartridge.

FIG. 9 is a view illustrating an example of the manufacturing process of the ink cartridge.

FIG. 10 is a view illustrating an example of the manufacturing process of the ink cartridge.

FIG. 11 is a view illustrating an example of a state in which the ink cartridge is mounted to a printing apparatus.

FIG. 12 is a view illustrating an example of the state in which the ink cartridge is mounted to the printing apparatus.

### DESCRIPTION OF EMBODIMENTS

Hereinafter, an embodiment of the present invention will be described with reference to the drawings. Note that this invention is not limited by the embodiment. In addition, constituent elements in the following embodiment include those that can be easily replaced by those skilled in the art or those that are substantially the same.

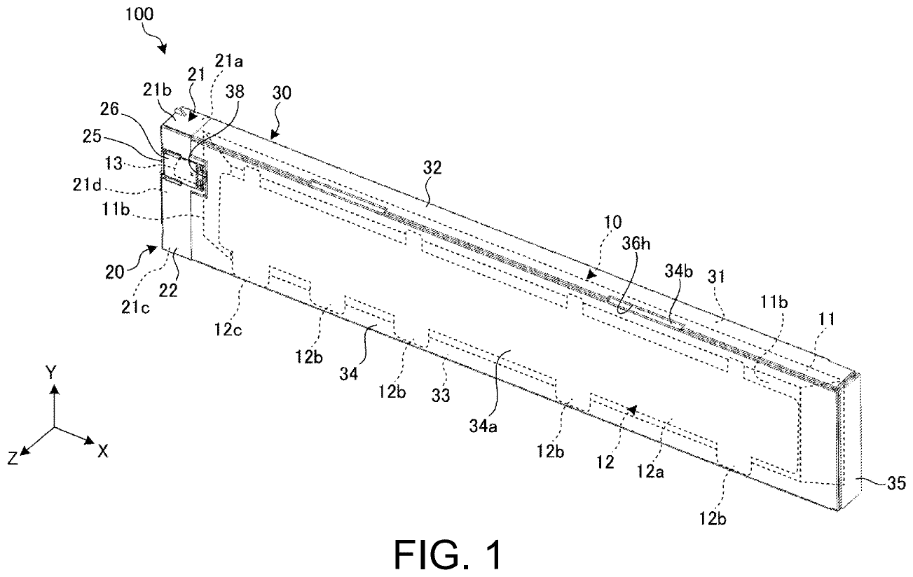

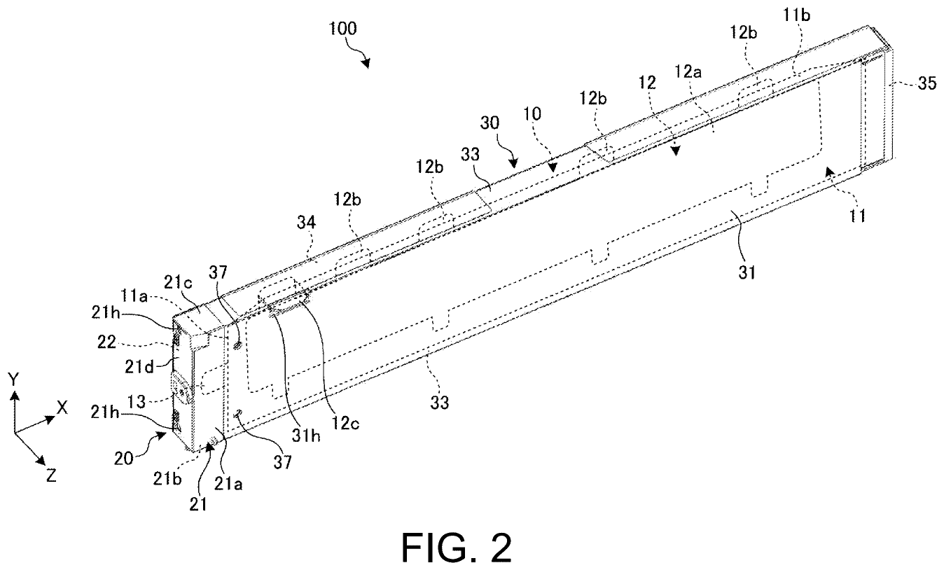

FIGS. 1 to 3 are views illustrating an example of an ink cartridge 100 according to the present embodiment. FIG. 1 and FIG. 2 are perspective views, and FIG. 2 is an exploded perspective view. As illustrated in FIG. 1 to FIG. 3, the ink cartridge 100 is replaceably mounted to a printing apparatus, and is used as a supply source that supplies ink to the printing apparatus.

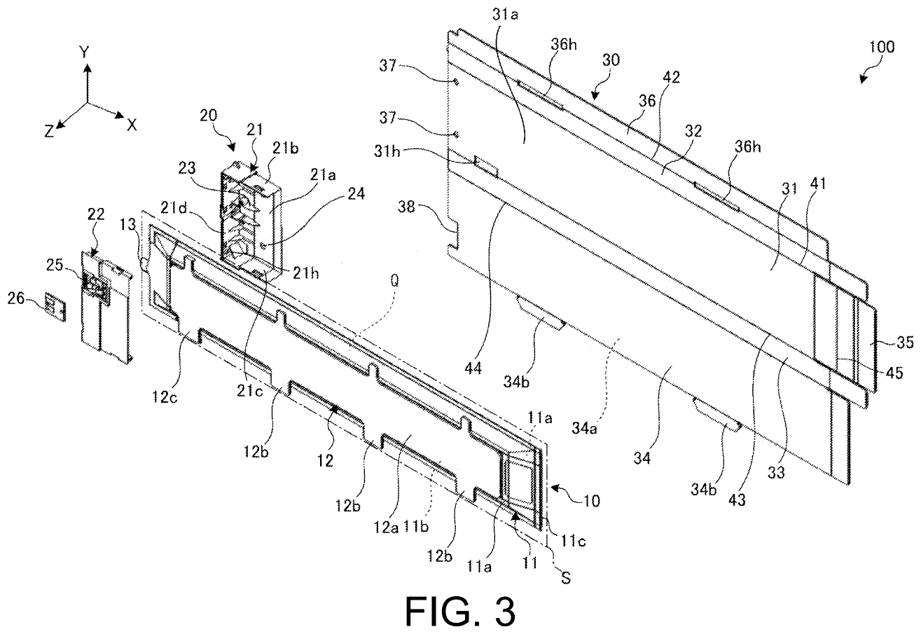

The ink cartridge 100 according to the present embodiment has, for example, a rectangular plate shape being is long in one direction. Hereinafter, when directions of the ink cartridge 100 are described, XYZ coordinates are used. That is, the longitudinal direction of the ink cartridge 100 is defined as an X direction. In addition, the width direction orthogonal to the longitudinal direction is defined as a Y direction, and the thickness direction orthogonal to the X direction and the Y direction is defined as a Z direction. The ink cartridge 100 includes an ink pack unit 10, a head unit 20, and a case unit 30. Note that, in FIG. 3, the case unit 30 is illustrated in an unfolded state.

The ink pack unit 10 includes a bag member 11 and a rib member 12. The bag member 11 is made of flexible material and is shaped like bag. The bag member 11 has, for example, a rectangular outer shape, but is not limited to this shape. The bag member 11 is formed, for example, in a state in which the peripheral edge portions along respective sides of two sheet-shaped members 11a are joined by fusion or the like. An opening portion corresponding to a spout 13 to be described later is formed in a part of a joint portion 11c of the sheet-shaped members 11a. The bag member 11 houses an ink Q inside, that is, the inner side with respect to the joint portion 11c of the sheet-shaped members 11a. The inside of the bag member 11 is sealed in a state of housing the ink Q. The bag member 11 shrinks in volume housing the ink as the remaining amount of the ink Q housed inside decreases. That is, the ink Q is consumed and discharged from the bag member 11 in a state of being filled with the ink Q, so that the bag member 11 shrinks in the Z direction according to the discharge amount. Note that the bag member 11 may be formed by folding and bonding, for example, one sheet-shaped member.

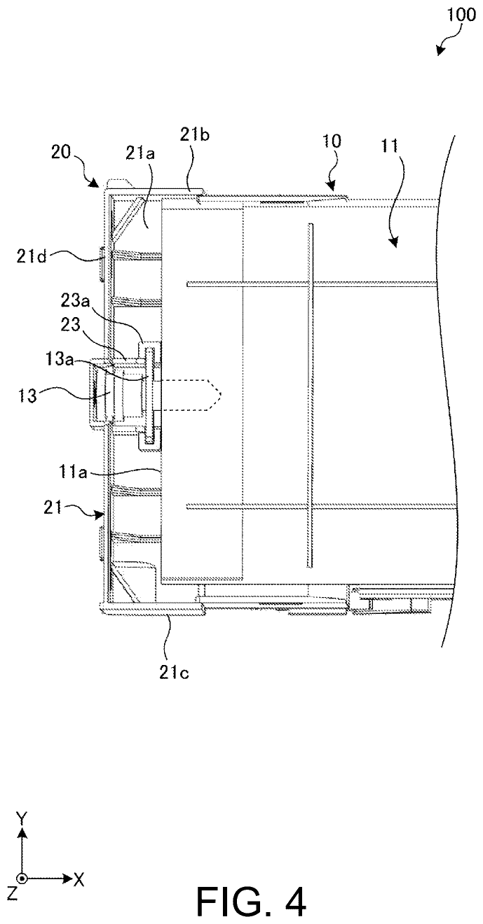

The bag member 11 has the spout 13. The spout 13 is provided at an end portion in the X direction. FIG. 4 is an enlarged view of a part of the inside of the ink cartridge 100. As illustrated in FIG. 4, the spout 13 discharges the ink Q housed inside the bag member 11 to the outside. The spout 13 is connected to the printing apparatus via, for example, the head unit 20 in a state where the ink cartridge 100 is mounted to the printing apparatus. The ink Q discharged from the spout 13 is supplied to the printing apparatus. The spout 13 is disposed at one end portion in the longitudinal direction of the bag member 11 formed in, for example, a rectangular shape. The spout 13 has a flange portion 13a overhanging in the radial direction. The flange portion 13a is housed and held in a flange housing part 23a described later.

Returning to FIG. 2, the rib member 12 is formed using, for example, a first material having a predetermined bending strength to prevent deformation of the rib member 12 when the ink cartridge 100 is connected to the printing apparatus. Examples of the first material include a plastic material (non-biodegradable plastic material) such as polypropylene. By forming the rib member 12 using such a non-biodegradable plastic material, the rigidity of the rib member 12 can be secured while suppressing the cost. The rib member 12 formed using the first material has a tensile strength of 630 to 800 kgf/cm² and a bending flexural modulus of 25,000 to 30,000 kgf/cm². The rib member 12 is fixed to the bag member 11 so as to move along with shrinkage of the bag member 11. The rib member 12 is fixed in a state of being parallel to a reference plane S including the joint portion 11c of the two sheet-shaped members 11a of the bag member 11. Note that the reference plane S is a virtual plane that does not actually exist. Note that the reference plane S may be set as a virtual plane not including the joint portion 11c. In the sheet-shaped member 11a, a fixing portion 11b to which the rib member 12 is fixed has a planar shape following the shape of the rib member 12. Note that the fixing portion 11b may be formed in a planar shape along the reference plane S in advance. By being provided with the rib member 12, the bag member 11 is deformed along the rib member 12 when the bag member is deformed due to the decrease in the remaining amount of ink. Therefore, distortion of the bag member 11 is suppressed. The rib 12 member is fixed to an attachment surface 11b of the bag member 11. The attachment surface 11b is formed, for example, along an XY plane.

The rib member 12 has a base portion 12a, overhang portions 12b, and a projection 12c. The base portion 12a has a rectangular shape and is formed to have a dimension corresponding to the bag member 11. The base portion 12a is fixed to the bag member 11. The overhang portions 12b are portions overhanging in the width direction (direction orthogonal to the longitudinal direction) from the base portion 12a. The projection 12c is a portion protruding from the overhang portion 12b in the thickness direction of the base portion 12a. The projection 12c is provided so as to protrude to the outside from a through hole 31h described later of the case unit 30 when the remaining amount of ink becomes smaller than a predetermined value. The printing apparatus is provided with a detection device detecting, for example, the projection 12c protruding from the through hole 31h or the projection 12c protruding from the through hole 31h beyond a predetermined protrusion amount. In the printing apparatus, when the detection device detects the projection 12c protruding as described above, it is determined that the remaining amount of ink in the ink cartridge 100 is equal to or less than a predetermined amount.

The head unit 20 is coupled to the ink pack unit 10. The head unit 20 is connected to the printing apparatus. The head unit 20 has a body member 21 and a lid member 22. The body member 21 and the lid member 22 are each formed using, for example, the first material having a predetermined bending strength to prevent deformation of the body member 21 and the lid member 22 when connected to the printing apparatus. Examples of the first material include a plastic material (non-biodegradable plastic material) such as polypropylene. By forming the body member 21 and the lid member 22 using such a non-biodegradable plastic material, the rigidity of the body member 21 and the lid member 22 can be secured while suppressing the cost. The body member 21 and the lid member 22 formed using the first material have a tensile strength of 630 to 800 kgf/cm² and a bending flexural modulus of 25,000 to 30,000 kgf/cm².

The body member 21 has a basal portion 21a, side portions 21b and 21c, and an opposing portion 21d. The basal portion 21a supports the bag member 11 of the ink pack unit 10. The side portions 21b and 21c are disposed on both sides in the width direction with respect to the basal portion 21a. The opposing portion 21d is a portion facing the printing apparatus in a state where the ink cartridge 100 is mounted to the printing apparatus. The opposing portion 21d is provided with positioning holes 21h. The positioning holes 21h are provided, for example, at both end portions in the Y direction in the opposing portion 21d. Into the positioning holes 21h, positioning pins on the printing apparatus side are inserted, respectively, in a state where the ink cartridge 100 is mounted to the printing apparatus. By inserting the positioning pins on the printing apparatus side into the positioning holes 21h, respectively, positioning is performed between the printing apparatus side and the ink cartridge 100. By forming the body member 21 using a non-biodegradable plastic material, rigidity of the opposing portion 21d is secured, so as to allow positioning between the printing apparatus side and the ink cartridge 100 appropriately.

The body member 21 has a spout mounting portion 23 and position alignment portions 24. The spout mounting portion 23 and the position alignment portions 24 are provided in the basal portion 21a. To the spout mounting portion 23, the spout 13 provided in the bag member 11 of the ink pack unit 10 is mounted. The spout mounting portion 23 has the flange housing part 23a. The flange housing part 23a houses the flange portion 13a of the spout 13. The spout mounting portion 23 is configured to position the ink pack unit 10 by allowing the flange portion 13a of the spout 13 to be housed in the flange housing part 23a (see FIG. 4). The position alignment portions 24 are hole portions formed in the body member 21. The position alignment portions 24 are used when position alignment with the case unit 30 described later is performed.

The lid member 22 is mounted so as to cover the opening portion of the body member 21. The lid member 22 has a board attaching portion 25. The board attaching portion 25 is a portion to which a board 26 is mounted. The board 26 is a storage medium in which information related to the ink cartridge 100 is stored. The information stored in the board 26 is used in the printing apparatus.

The case unit 30 houses the ink pack unit 10 and the head unit 20 so that a part of the head unit 20 is exposed. The case unit 30 has a supporting portion 31, side portions 32 and 33, a facing portion 34, and an end portion 35. The case unit 30 is formed using a second material differently from the rib member 12 and the head unit 20. In the present embodiment, the second material is, for example, a paper material. More specifically, as the paper material, cardboard, thick paper, and the like can be used, for example. The second material is not limited to the paper material, and for example, other biodegradable materials including a wooden material, a biodegradable plastic material, and the like may be used.

The case unit 30 is formed as a single member including all of the supporting portion 31, the side portions 32 and 33, the facing portion 34, and the end portion 35. By bending boundary portions between the respective portions, the case unit 30 is formed in a box shape capable of housing the ink pack unit 10 and the head unit 20. The case unit 30 is formed as one flat sheet of paper in a state where the respective portions are unfolded. Therefore, when the case unit 30 before assembly is stored, space saving can be achieved by stacking the case units in a predetermined space.

The supporting portion 31 has an inner surface 31a to which an adhesive member such as a double-sided tape is attached. To the supporting portion 31, the ink pack unit 10 is fixed via the adhesive member. The supporting portion 31 has position alignment portions 37. The position alignment portions 37 are hole portions formed in the supporting portion 31. The position alignment portions 37 are used when position alignment with the head unit 20 described above is performed. That is, when position alignment is performed between the head unit 20 and the case unit 30, the position alignment portions 24 of the head unit 20 and the position alignment portions 37 of the case unit 30 are made to overlap.

The supporting portion 31 has the through hole 31h. The through hole 31h is formed so as to penetrate the inside and the outside of the case unit 30 in the assembled state of the case unit 30. In a state where the ink pack unit 10 is fixed to the supporting portion 31, the through hole 31h is disposed at a position corresponding to the projection 12c of the rib member 12. More specifically, in a state where the ink pack unit 10 is fixed to the supporting portion 31, the through hole 31h is disposed at a position overlapping the projection 12c of the rib member 12 when viewed from a direction perpendicular to the supporting portion 31. With this arrangement, when the remaining amount of ink housed in the bag member 11 becomes smaller than a predetermined value, the projection 12c of the rib member 12 protrudes to the outside from the through hole 31h of the case unit 30.

The side portions 32 and 33 are connected to both sides in the width direction with respect to the supporting portion 31. The side portion 32 is provided with a bending margin portion 36. Locking holes 36h are formed in the bending margin portion 36. Into the locking holes 36h, locking pieces 34b of the facing portion 34 described later is inserted, respectively.

The facing portion 34 is connected to the side portion 33. The facing portion 34 is disposed so as to face the supporting portion 31 in a state where the case unit 30 is assembled. The facing portion 34 has a print surface 34a on the front surface side. On the print surface 34a, information related to ink, for example, is printed. As described above, by forming the case unit 30 using a paper material, the information related to the ink can be given to the surface of the case unit 30 in a visible state without using a label or the like.

The facing portion 34 has the locking pieces 34b. The locking pieces 34b are inserted into the locking holes 36h, respectively, of the bending margin portion 36 and locked to the bending margin portion 36 when the case unit 30 is assembled. In the facing portion 34, a position alignment portion 38 is formed. The position alignment portion 38 is a cutout portion provided in the facing portion 34. The position alignment portion 38 is disposed at a position corresponding to the board attaching portion 25 of the lid member 22 of the head unit 20 in a state where the locking pieces 34b are inserted into the locking holes 36h, respectively.

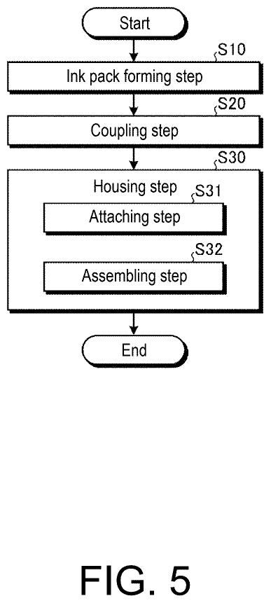

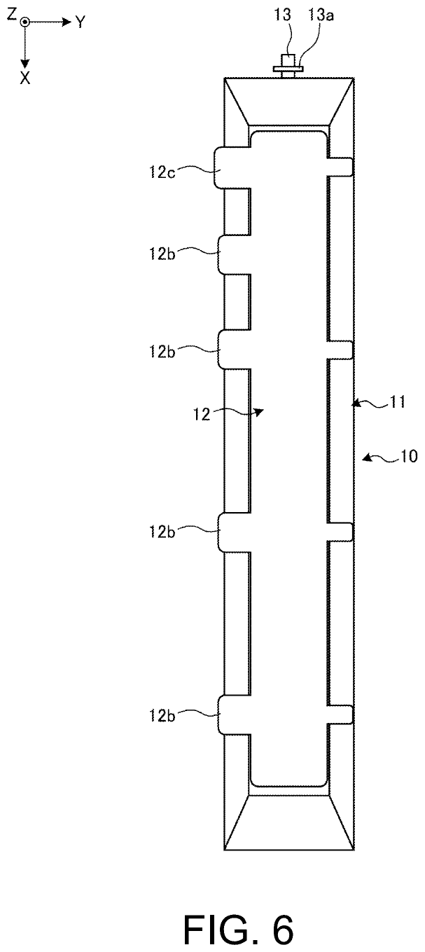

Next, a manufacturing method of the ink cartridge 100 formed as described above will be described. FIG. 5 is a flowchart illustrating an example of the manufacturing method of the ink cartridge 100 according to the present embodiment. FIG. 6 to FIG. 10 are views illustrating an example of the manufacturing process of the ink cartridge 100. As illustrated in FIG. 5, the manufacturing method of the ink cartridge according to the present embodiment includes an ink pack forming step (S10), a coupling step (S20), and a housing step (S30).

In the ink pack forming step S10, the ink pack unit 10 is formed by fixing the rib member 12 to the bag member 11 housing the ink. In the ink pack forming step S10, as illustrated in FIG. 6, the rib member 12 is fixed to the attachment surface 11b of the bag member 11 so as to move along with shrinkage of the bag member 11.

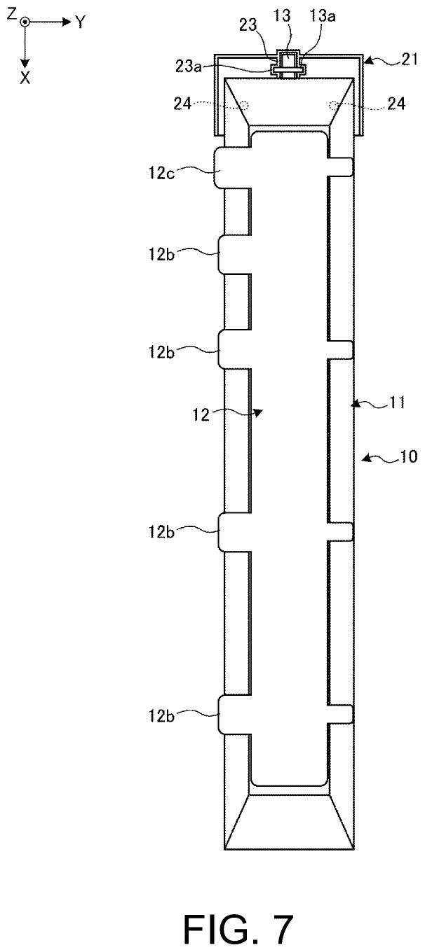

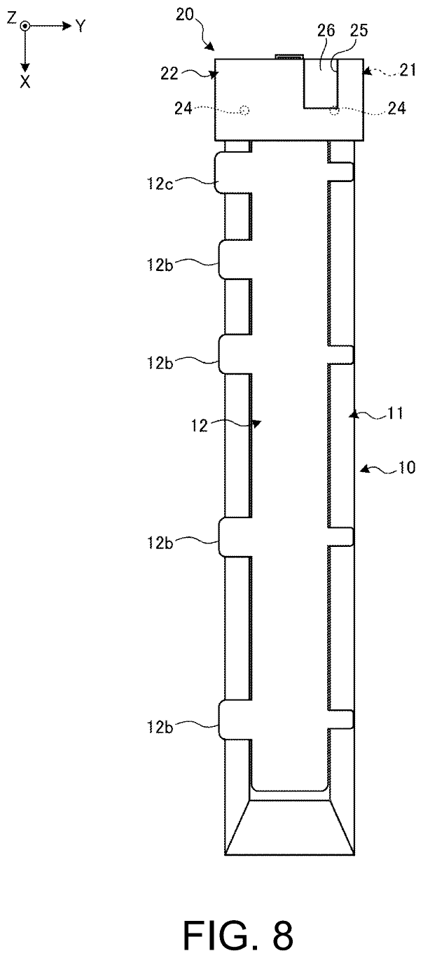

In the coupling step S20, the head unit 20 is coupled to the ink pack unit 10. As illustrated in FIG. 7, in the coupling step S20, the spout 13 of the ink pack unit 10 is mounted to the spout mounting portion 23 of the body member 21 of the head unit 20. At this time, the flange portion 13a provided in the spout 13 is housed in the flange housing part 23a of the spout mounting portion 23. As a result, the ink pack unit 10 and the body member 21 are positioned. After the spout 13 is mounted to the spout mounting portion 23, the lid member 22 is mounted on the body member 21 as illustrated in FIG. 8. As a result, the head unit 20 in a state where the ink pack unit 10 is coupled is formed.

In the housing step S30, the ink pack unit 10 and the head unit 20 are housed in the case unit 30 so that a part of the head unit 20 is exposed. The housing step S30 includes an attaching step S31 and an assembling step S32.

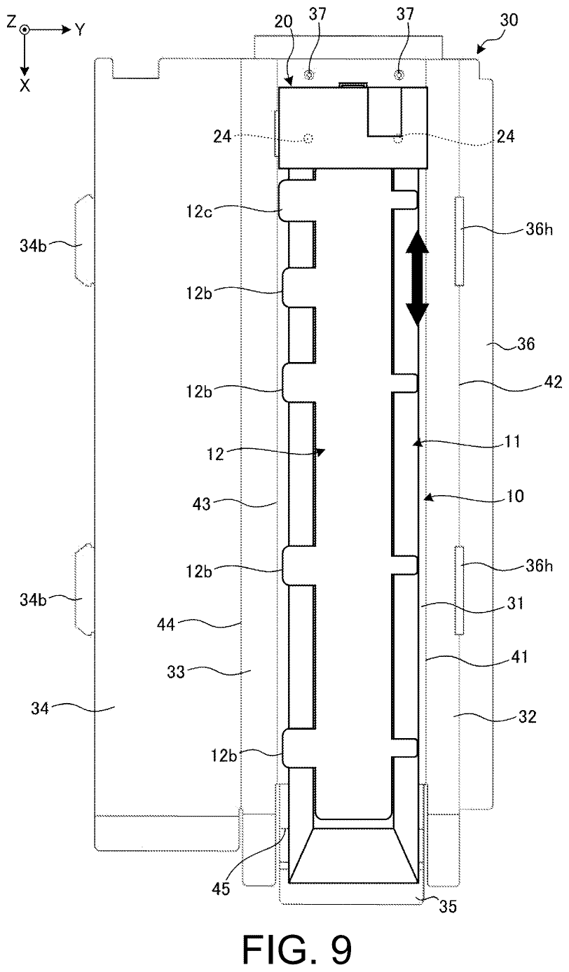

In the attaching step S31, as illustrated in FIG. 9, first, the ink pack unit 10 and the head unit 20 are subjected to position alignment with respect to the case unit 30 in the unfolded state. At the time of position alignment, position alignment is performed such that the position alignment portions 24 of the head unit 20 and the position alignment portions 37 of the case unit 30 correspond to each other, and the board attaching portion 25 of the head unit 20 and the position alignment portion 38 of the case unit 30 correspond to each other.

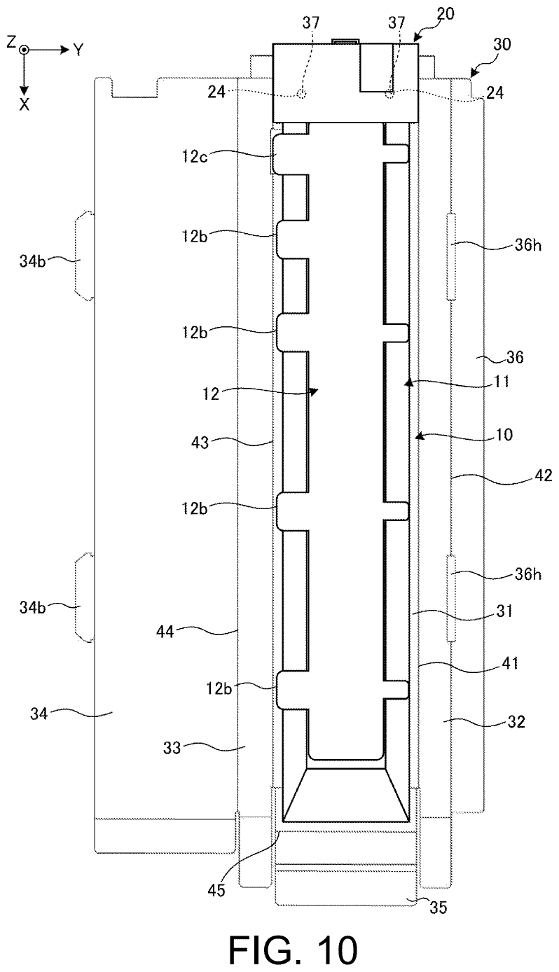

After the position alignment is completed, as illustrated in FIG. 10, a surface of the bag member 11 of the ink pack unit 10, the surface being opposite to a portion to which the rib member 12 is fixed, is fixed to the inner surface 31a of the supporting portion 31 of the case unit 30 with a double-sided tape (not illustrated) or the like.

In the assembling step S32, the case unit 30 is assembled from a state where the ink pack unit 10 and the head unit 20 are attached. In the assembling step S32, a boundary portion 41 between the supporting portion 31 and the side portion 32, a boundary portion 42 between the side portion 32 and the bending margin portion 36, a boundary portion 43 between the supporting portion 31 and the side portion 33, a boundary portion 44 between the side portion 33 and the facing portion 34, and a boundary portion 45 between the supporting portion 31 and the end portion 35 are each bent inward.

When each portion is bent, for example, the end portion 35 is first bent inward, and the side portion 32 and the bending margin portion 36 are bent so as to cover a part of the end portion 35. Next, the facing portion 34 is bent so that the locking pieces 34b are inserted into the locking holes 36h, respectively, of the bending margin portion 36. As a result, the case unit 30 can be assembled such that the projection 12c of the rib member 12 is disposed at a position corresponding to the through hole 31h of the case unit 30.

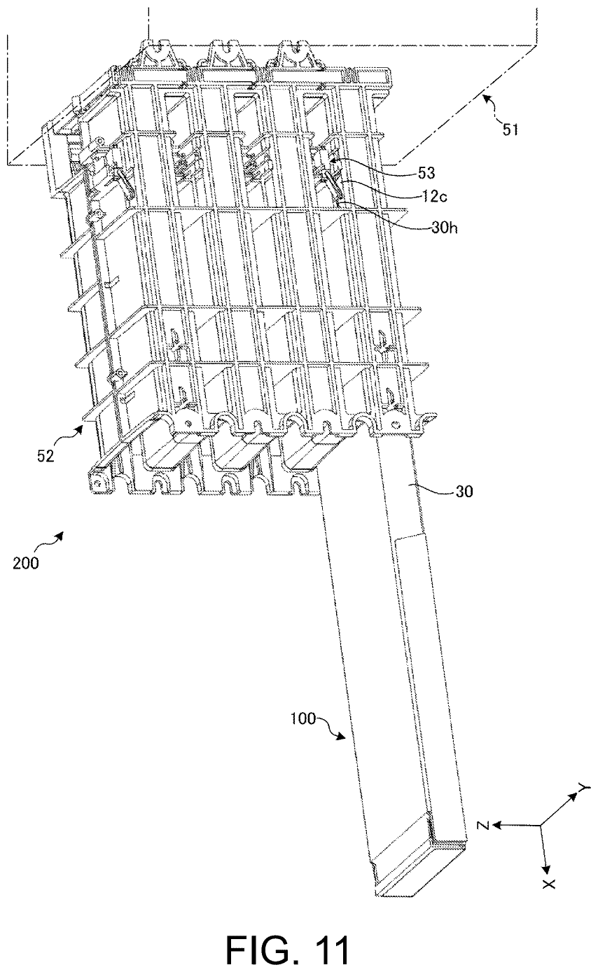

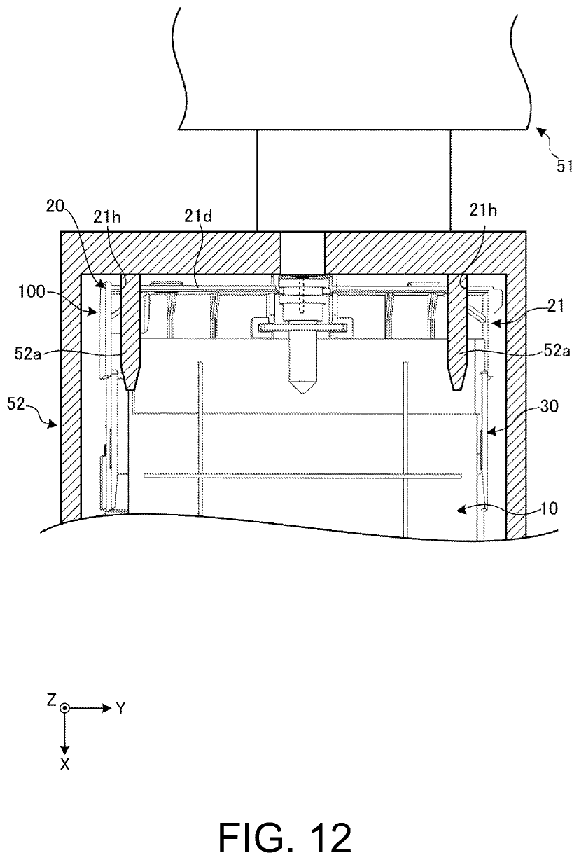

FIG. 11 and FIG. 12 are views illustrating an example of a state in which the ink cartridge 100 is mounted to a printing apparatus 200. FIG. 11 is a perspective view, and FIG. 12 is a partial cross-sectional view. The printing apparatus 200 illustrated in FIG. 11 is, for example, an inkjet printer. As illustrated in FIG. 11, the printing apparatus 200 includes a main body 51 and a mounting part 52. The main body 51 performs printing with ink. The mounting part 52 is provided in the main body 51. To the mounting part 52, the ink cartridge 100 as described above as an ink supply source is mounted.

The main body 51 has a head that ejects, for example, ink. The head receives supply of ink from the ink cartridge 100 mounted to the mounting part 52. The printing apparatus 200 ejects ink supplied from the ink cartridge 100 onto a medium or the like to perform printing on the medium.

As illustrated in FIG. 11, in a state where the ink cartridge 100 is mounted to the printing apparatus 200, the shape before mounting is maintained. That is, the rib member 12 of the ink pack unit 10 and the head unit 20 have strength to prevent deformation by the pressure applied at the time of mounting. Similarly, the case unit 30 has strength to prevent deformation by pressure applied at the time of mounting. In addition, in the ink cartridge 100, the projection 12c is configured to protrude from the through hole 31h of the case unit 30. The projection 12c protrudes to the outside from the through hole 31h when the remaining amount of ink becomes smaller than a predetermined value. The printing apparatus 200 is provided with a detection device 53. The detection device 53 detects the projection 12c protruding from the through hole 31h or the projection 12c protruding from the through hole 31h beyond a predetermined protrusion amount. In the printing apparatus 200, when the detection device 53 detects protrusion of the projection 12c, it is determined that the remaining amount of ink in the ink cartridge 100 is equal to or less than a predetermined amount.

As illustrated in FIG. 12, in the body member 21 of the head unit 20, the opposing portion 21d faces the mounting part 52 in a state where the ink cartridge 100 is mounted to the printing apparatus 200 (mounting part 52). Into the positioning holes 21h of the opposing portion 21d, positioning pins 52a on the mounting part 52 side are inserted, respectively, in a state where the ink cartridge 100 is mounted to the mounting part 52. By inserting the positioning pins on the printing apparatus side into the positioning holes 21h, respectively, positioning is performed between the printing apparatus side and the ink cartridge 100. By forming the body member 21 using a non-biodegradable plastic material, rigidity of the opposing portion 21d is secured, so as to allow positioning between the printing apparatus side and the ink cartridge 100 appropriately.

As described above, the ink cartridge 100 according to the present embodiment includes: the ink pack unit 10 having the bag member 11 and the rib member 12, the bag member 11 housing ink and shrinking in volume housing the ink as a remaining amount of the ink decreases, the rib member 12 having a flat plate shape and being fixed to the bag member 11 so as to move along with shrinkage of the bag member 11; the head unit 20 coupled to the ink pack unit 10 and connected to the printing apparatus; and the case unit 30 that houses the ink pack unit 10 and the head unit 20 such that a part of the head unit 20 is exposed, in which the ink pack unit 10 has a surface fixed to the inner surface of the case unit 30, the surface being opposite to a portion to which the rib member 12 is fixed of the bag member 11, the case unit 30 has the through hole 31h penetrating inside and outside, the rib member 12 has a projection 12c provided so as to protrude outside from the through hole 31h when the remaining amount of the ink becomes smaller than a predetermined value, the rib member 12 and the head unit 20 are formed using the first material having a predetermined bending strength to prevent deformation of the rib member 12 and the head unit 20 when connected to the printing apparatus, and the case unit 30 is formed using the second material different from the first material.

According to this configuration, the rib member 12 and the head unit 20 are formed using the first material having a predetermined bending strength to prevent deformation of the rib member 12 and the head unit 20 when connected to the printing apparatus, whereas the case unit 30 is formed using the second material different from the first material. Therefore, when the non-biodegradable plastic is used as the first material, the case unit 30 is formed of the second material different from the non-biodegradable plastic. In this case, usage of the non-biodegradable plastic material in the entire ink cartridge 100 can be reduced. In addition, since the rib member 12 and the head unit 20 are formed using the first material having a predetermined bending strength to prevent deformation of the rib member 12 and the head unit 20 when connected to the printing apparatus, rigidity of the rib member 12 and the head unit 20 can be secured.

In the ink cartridge 100 according to the present embodiment, the second material is a paper material or a biodegradable plastic material. According to this configuration, the material constituting the case unit 30 can be easily recycled.

In the ink cartridge 100 according to the present embodiment, the second material is a paper material, and the case unit 30 has the print surface 34a on which information related to the ink is printed on a front surface side. According to this configuration, the information related to the ink can be given to the case unit 30 in a visible state without separately forming a label or the

In the ink cartridge 100 according to the present embodiment, the head unit 20 and the case unit 30 have position alignment portions 24, and 37 and 38, respectively, at corresponding positions. According to this configuration, the accuracy in assembling the ink cartridge 100 can be secured.

In the ink cartridge 100 according to the present embodiment, the ink pack unit 10 has the spout 13 that is provided in the bag member 11 and discharges the ink, and the head unit 20 has the spout mounting portion 23 to which the spout 13 is mounted while positioning the ink pack unit 10. According to this configuration, positioning can be performed between the ink pack unit 10 and the head unit 20 by mounting the spout 13 to the spout mounting portion 23.

In the ink cartridge 100 according to the present embodiment, the rib member 12 and the head unit 20 have a tensile strength of 630 to 800 kgf/cm² and a bending flexural modulus of 25,000 to 30,000 kgf/cm². According to this configuration, it is possible to secure sufficient bending strength to prevent the rib member 12 and the head unit 20 formed using the first material from being deformed when connected to the printing apparatus.

The manufacturing method of the ink cartridge 100 according to the present embodiment includes: the ink pack forming step S10 of forming the ink pack unit 10 by fixing the rib member 12 to the bag member 11 such that the rib member 12 moves along with shrinkage of the bag member 11 of the ink pack unit 10, the bag member 11 housing ink and shrinking in volume as a remaining amount of the ink decreases, the rib member 12 having a flat plate shape, being formed using the first material having a predetermined bending strength to prevent deformation of the rib member 12 when connected to the printing apparatus, and having the predetermined projection 12c; the coupling step S20 of coupling the head unit 20 to the ink pack unit 10, the head unit 20 being formed using the first material and connected to the printing apparatus; and the housing step S30 of housing the ink pack unit 10 and the head unit 20 in the case unit 30 so that a part of the head unit is exposed, the case unit 30 being formed using the second material differently from the rib member 12 and the head unit 20 and having the predetermined through hole 31h.

According to this configuration, the ink cartridge 100 capable of reducing usage of the non-biodegradable plastic material can be efficiently produced.

In the manufacturing method of the ink cartridge 100 according to the present embodiment, the housing step S30 further includes: the attaching step S31 of attaching the ink pack unit 10 and the head unit 20 to the case unit 30 in an unfolded state by performing position alignment of the ink pack unit 10 and the head unit 20 to the case unit 30; and the assembling step S32 of assembling the case unit 30 in a state where the ink pack unit 10 and the head unit 20 are attached to the case unit 30. According to this configuration, the housing step S30 can be efficiently performed.

In the manufacturing method of the ink cartridge 100 according to the present embodiment, the head unit 20 and the case unit 30 have position alignment portions 24, and 37 and 38, respectively, at corresponding positions, and the position alignment portions 24 on a side of the head unit 20 and the position alignment portions 37 and 38 of the case unit 30 are coupled to each other to perform the position alignment. According to this configuration, position alignment between the head unit 20 and the case unit 30 can be performed with accuracy.

In the manufacturing method of the ink cartridge 100 according to the present embodiment, in the attaching step S31, a surface of the bag member 11 of the ink pack unit 10 is fixed to the inner surface of the case unit 30, the surface being opposite to a portion to which the rib member 12 is fixed, and, in the assembling step S32, the case unit 30 is assembled such that the through hole 31h is disposed at a position where the projection 12c of the rib member 12 protrudes to the outside of the case unit 30 when a remaining amount of the ink becomes smaller than a predetermined value. According to this configuration, the rib member 12 can be appropriately provided by the attaching step S31 and the assembling step S32.

In the manufacturing method of the ink cartridge 100 according to the present embodiment, the bag member 11 has the sheet-shaped member 11a, and the sheet-shaped member 11a forms a space that houses the ink by joining peripheral edge portions along the outer periphery of the sheet-shaped member 11a so as to leave a portion corresponding to a discharge port of the ink, and the rib member 12 is fixed in parallel to the reference plane including the joint portion of the sheet-shaped member 11a. According to this configuration, the rib member 12 can be disposed at an appropriate position and posture with respect to the bag member 11.

In the manufacturing method of the ink cartridge 100 according to the present embodiment, the rib member 12 and the head unit 20 have a tensile strength of 630 to 800 kgf/cm² and a bending flexural modulus of 25,000 to 30,000 kgf/cm². According to this configuration, it is possible to secure sufficient bending strength to prevent the rib member 12 and the head unit 20 formed using the first material from being deformed when connected to the printing apparatus.

In the manufacturing method of the ink cartridge 100 according to the present embodiment, the second material is a paper material or a biodegradable plastic material. According to this configuration, the material constituting the case unit 30 can be easily recycled.

The printing apparatus 200 according to the present embodiment includes: the main body 51 that performs printing with ink; and the mounting part 52 provided in the main body 51 and to which the ink cartridge 100 as a supply source of the ink is mounted. According to this configuration, it is possible to provide the printing apparatus 200 capable of appropriately connecting the ink cartridge 100 having less burden on the environment.

The technical scope of the present invention is not limited to the above embodiment, and can be appropriately modified without departing from the gist of the present invention. For example, in the above embodiment, although the case has been described as an example where the information related to the ink is printed on the print surface 34a of the facing portion 34 of the case unit 30, the present invention is not limited to this configuration. For example, a configuration may be adopted in which a label having printed information related to ink is attached to the surface of the case unit 30.

### REFERENCE SIGNS LIST

Q: ink; s10: ink pack forming step; S20: coupling step; S30: housing step; S31: attaching step; S32: step; PR: printing apparatus; 10: ink pack unit; 11: bag member; 11a, 35: end portion; 11b: attachment surface; 12: rib member; 12a: base portion; 12b: overhang portion; 12c: projection; 13: spout; 20: head unit; 21: body member; 21a: basal portion; 21b, 21c, 32, 33: side portion; 21d: opposing portion; 21h: positioning hole; 22: lid member; 23: spout mounting portion; 24, 37, 38: position alignment portion; 25: board attaching portion; 26: board; 30: case unit; 31: supporting portion; 31a: inner surface; 31h: through hole; 34: facing portion; 34a: print surface; 34b: locking piece; 36: bending margin portion; 36h: locking hole; 41, 42, 43, 44, 45: boundary portion; 100: ink cartridge

1. An ink cartridge comprising:
an ink pack unit having a bag member and a rib member, the bag member housing ink and shrinking in volume housing the ink as a remaining amount of the ink decreases, the rib member having a flat plate shape and being fixed to the bag member so as to move along with shrinkage of the bag member;
a head unit coupled to the ink pack unit and connected to a printing apparatus; and
a case unit that houses the ink pack unit and the head unit such that a part of the head unit is exposed,
wherein the ink pack unit has a surface fixed to an inner surface of the case unit, the surface being opposite to a portion to which the rib member is fixed of the bag member,
the case unit has a through hole penetrating inside and outside,
the rib member has a projection provided so as to protrude outside from the through hole when the remaining amount of the ink becomes smaller than a predetermined value,
the rib member and the head unit are formed using a first material having a predetermined bending strength to prevent deformation of the rib member and the head unit when connected to the printing apparatus, and
the case unit is formed using a second material different from the first material.

2. The ink cartridge as set forth in claim 1, wherein
the second material is a paper material or a biodegradable material.

3. The ink cartridge as set forth in claim 1, wherein
the second material is a paper material, and
the case unit has a print surface on which information related to the ink is printed on a front surface side.

4. The ink cartridge as set forth in claim 1, wherein
the head unit and the case unit have position alignment portions, respectively, at corresponding positions.

5. The ink cartridge as set forth in claim 1, wherein
the ink pack unit has a spout that is provided in the bag member and discharges the ink, and
the head unit has a spout mounting portion to which the spout is mounted while positioning the ink pack unit.

6. The ink cartridge as set forth in claim 1, wherein
the rib member and the head unit have a tensile strength of 630 to 800 kgf/cm² and a bending flexural modulus of 25,000 to 30,000 kgf/cm².

7. A manufacturing method of an ink cartridge, comprising:
an ink pack forming step of forming an ink pack unit in which a rib member is fixed to a bag member so as to move along with shrinkage of the bag member;
a coupling step of coupling a head unit to the ink pack unit; and
a housing step of housing the ink pack unit and the head unit in a case unit so that a part of the head unit is exposed,
wherein the bag member houses ink and shrinks in volume as a remaining amount of the ink decreases;
the rib member has a flat plate shape and has a predetermined projection, the rib member being formed using a first material having a predetermined bending strength to prevent deformation of the rib member when connected to a printing apparatus;
the head unit is formed using the first material and connected to the printing apparatus; and
the case unit is formed using a second material different from the first material and has a predetermined through hole.

8. The manufacturing method of the ink cartridge as set forth in claim 7, wherein
the housing step further includes:
an attaching step of attaching the ink pack unit and the head unit to the case unit in an unfolded state by performing position alignment of the ink pack unit and the head unit to the case unit; and
an assembling step of assembling the case unit in a state where the ink pack unit and the head unit are attached to the case unit.

9. The manufacturing method of the ink cartridge as set forth in claim 8, wherein
the head unit and the case unit have position alignment portions, respectively, at corresponding positions, and
the position alignment portion on a side of the head unit and the position alignment portion of the case unit are coupled to each other to perform the position alignment of the head unit and the case unit.

10. The manufacturing method of the ink cartridge as set forth in claim 8, wherein,
in the attaching step, a surface of the bag member of the ink pack unit is fixed to an inner surface of the case unit, the surface being opposite to a portion to which the rib member is fixed, and,
in the assembling step, the case unit is assembled such that the through hole is disposed at a position where the projection of the rib member protrudes to an outside of the case unit when a remaining amount of the ink becomes smaller than a predetermined value.

11. The manufacturing method of the ink cartridge as set forth in claim 7, wherein
the bag member has a sheet-shaped member, and
the sheet-shaped member forms a space that houses the ink by joining an outer periphery of the sheet-shaped member so as to leave a portion corresponding to a spout that discharges the ink, and
the rib member is fixed in parallel to a reference plane including a joint portion of the sheet-shaped member.

12. The manufacturing method of the ink cartridge as set forth in claim 7, wherein
the rib member and the head unit have a tensile strength of 630 to 800 kgf/cm² and a bending flexural modulus of 25,000 to 30,000 kgf/cm².

13. The manufacturing method of the ink cartridge as set forth in claim 7, wherein
the second material is a paper material or a biodegradable material.

14. A printing apparatus comprising:
a main body that performs printing with ink; and
a mounting part provided in the main body and to which the ink cartridge as set forth in claim 6 claim 1 as a supply source of the ink is mounted.
